(19) United States
(12) Patent Application Publication
(10) Pub. No.: US 2011/0233200 A1
(43) Pub. Date: Sep. 29, 2011

(54) Microwavable food container where amount of added water is adjustable

(76) Inventor: Hilary Rich, Los Angeles, CA (US)

(21) Appl. No.: 12/659,917

(22) Filed: Mar. 25, 2010

(51) Int. Cl. H05B 6/80

(52) U.S. Cl. 219/725

(57) ABSTRACT

A microwavable food container composed of a water pan for containing a liquid therein, a support member placed on the water pan and having a plurality of through holes, a top member covered on the support member, and at least one water tank mounted in the water pan. In light of this, the user can fill the at least one water tank with water to adjustably control the amount of added water without any measuring cup.

### BACKGROUND OF THE INVENTION

1. Field of the Invention

The present invention relates generally to a food container for microwave heating, and more particularly, to a microwavable food container where the amount of added water is adjustable.

2. Description of the Related Art

A commercially available microwavable food container is generally composed of a sealable box having one or multiple chambers for placing food. Another microwavable food container further includes a pan for containing added water in such a way that when the water in the pan is heated in a microwave oven, the water becomes vapor and the vapor rises up to a chamber where the food is placed for heating the food. In this way, the microwave oven can function like a steamer.

In the aforesaid microwavable food container, the required amount of the added water in the pan should be adjustable according to the required time for heating the food. If the water added into the pan is too little, the heating effect will be insufficient or the internal moisture of the heated food is evaporated very much to bring forth bad taste of the food. If the added water into the pan is too much, the consumed time and energy for heating and transforming the water into vapor will increase. While using the aforesaid microwavable food container, a user mostly adds approximate amount of the water into the pan by intuition or adds specific amount of the water into the pan by a measuring cup. However, such intuitive addition of the water may result in too much or too little amount of the added water. Although the measuring cup can be prepared for specific amount of the added water, it is slightly inconvenient that the user needs to additionally use the measuring cup to come up with a specific amount of the added water. In other words, the commercially available microwavable food container still needs improvement.

### SUMMARY OF THE INVENTION

The primary objective of the present invention is to provide a microwavable food container, in which the amount of added water is adjustable without any measuring cup.

The foregoing objective of the present invention is attained by the microwavable food container composed of a water pan for containing water therein. The water pan includes a plurality of water tanks each having a specific capacity. In light of this, the user can fill one or multiple water tanks with water to need none of any measuring cups for adjustable amount of added water.

In the microwavable food container, the water pan further includes at least one water tank formed therein and having a specific capacity.

In the microwavable food container, the water pan further includes an internal bottom periphery and an annular wall formed on the internal bottom periphery and defining the at least one water tank. The annular wall has a top side aligned with the water level of the at least one water tank while it is full of the water.

### BRIEF DESCRIPTION OF THE DRAWINGS

FIG. 1 is an exploded view of a preferred embodiment of the present invention.

FIG. 2 is a perspective view of the preferred embodiment of the present invention.

FIG. 3 is a top view of the preferred embodiment of the present invention.

FIG. 4 is a sectional view taken from a line 4-4 indicated in FIG. 3.

### DETAILED DESCRIPTION OF PREFERRED EMBODIMENTS

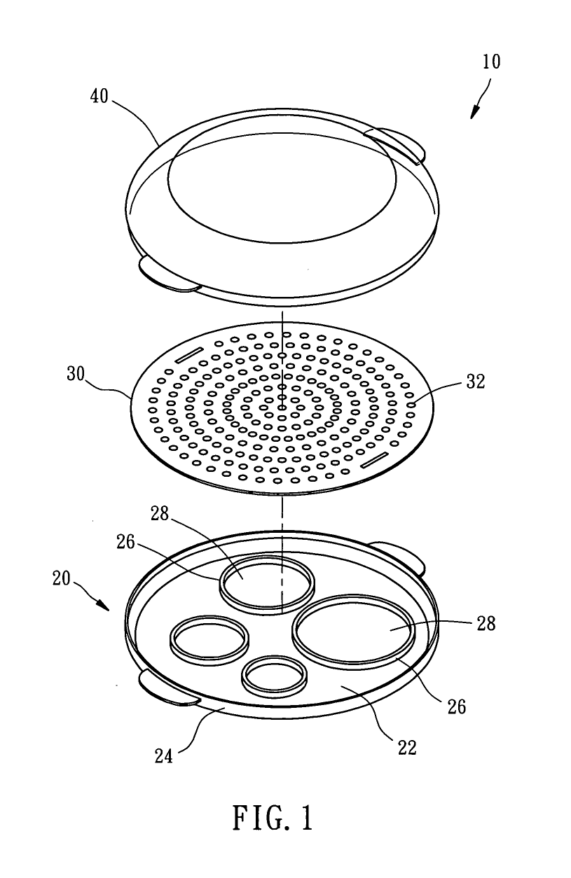

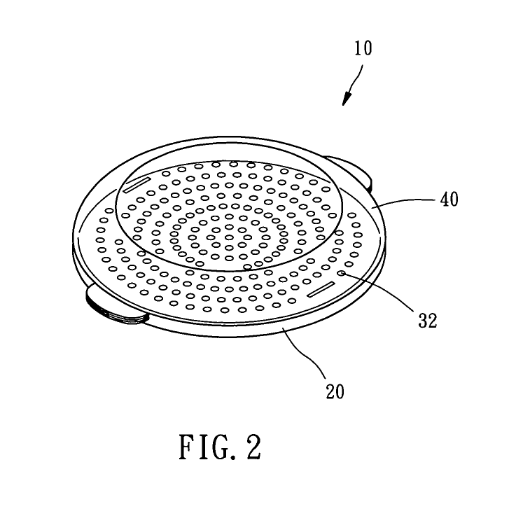

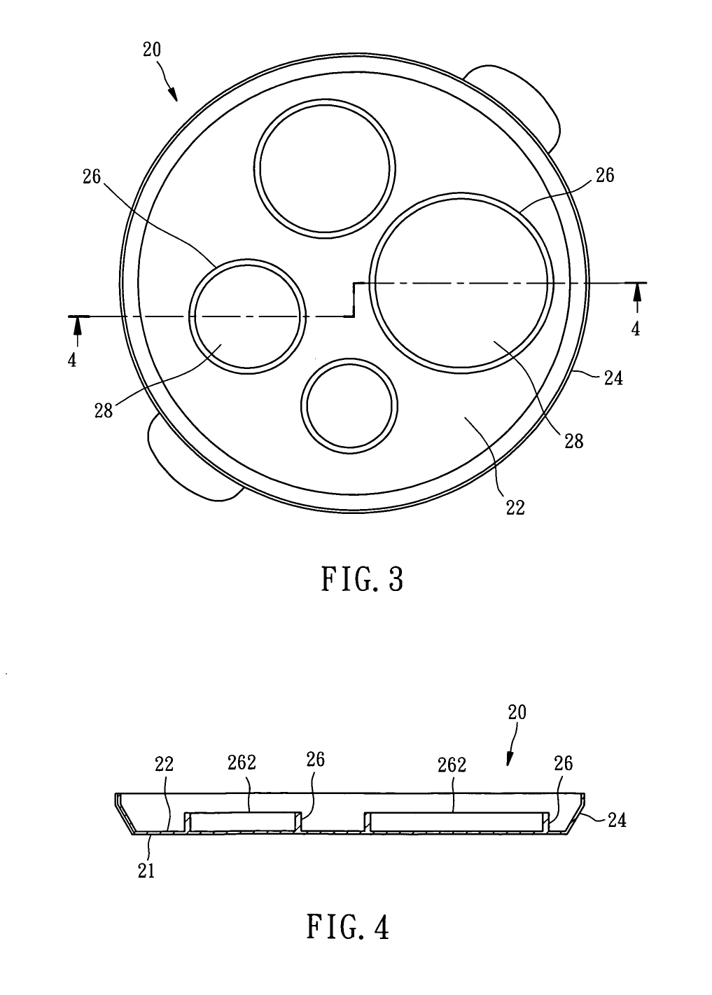

Referring to FIGS. 1-4, a microwavable food container 10 where the amount of added water is adjustable in accordance with a preferred embodiment of the present invention is composed of a water pan 20, a support member 30, and a top member 40.

The water pan 20 is made of heat-resistant plastic in one piece and includes a circular bottom portion 21, an annular peripheral wall 24 protruding upward from a peripheral edge of the bottom portion 22 for a predetermined height, and four annular walls 26 located on the bottom portion 22 and each having a diameter different from either of the others thereof. Each of the four annular walls 26 and the bottom portion 20 jointly defines a water tank 28 having a specific capacity. As shown in FIG. 4, each of the annular walls 26 has a top side 262 aligned with a water level of the water tank 28 while the water tank 28 is full of the water.

The support member 30 is also made of heat-resistant plastic in one piece. When in use, the support member 30 is placed on the water pan 20 for placing food thereon. As shown in FIG. 1, the support member 30 is disk-shaped and provided with a plurality of through holes 32 arranged therethrough for circulation of vapor.

The top member 40 is made of transparent heat-resistant plastic in one piece. While in use, the top member 40 is covered on the support member 30 and engaged with the water pan 20 in such a way that a closed space is formed between the top member 40 and the support member 30 for placing and heating the food therein.

Because the microwavable food container 10 can be labeled with a capacity (not shown) of each of the water tanks 28 at the package, user manual, or internal bottom periphery 22 of each of the water tanks 28 of the present invention, when the microwavable food container 10 is used, the user does not need any measuring cup but one or more water tanks 28 to know how much the added water is and thus it is easy to adjustably control the amount of the added water. Besides, how the food in the microwavable food container 10 is heated is totally the same as the conventional one. In other words, when the water is added into at least one of the water tanks 28, the microwavable food container 10 can be placed into a microwave oven for microwave heating; meanwhile, the water in the water tank 28 is heated to become vapor and then the vapor rises through the through holes 28 up to the closed space to heat the food.

In conclusion, the microwavable food container 10 of the present invention works like that the water tanks 28 having specific capacities are formed on the internal bottom periphery 22 and thus the user only needs to add the water into one or more water tanks 28 to adjustably control the amount of the added water without any measuring cup.

Although the present invention has been described with respect to a specific preferred embodiment thereof, it is in no way limited to the specifics of the illustrated structures but changes and modifications may be made within the scope of the appended claims.

What is claimed is:

1. A microwavable food container where the amount of added water is adjustable, comprising:
a water pan for containing a liquid;
a support member mounted to the water pan and having a plurality of through holes running therethrough;
a top member covered on the support member; and
at least one water tank formed in the water pan.

2. The microwavable food container as defined in claim 1, wherein the water pan further comprises an internal bottom periphery and at least one annular wall, the at least one annular wall being located on the internal bottom periphery jointly for defining the at least one water tank therebetween.

3. The microwavable food container as defined in claim 2, wherein the annular wall comprises a top side aligned with the water level of the at least one tank while it is full of the water.

4. The microwavable food container as defined in claim 1, wherein the at least one water tank is plural in number.

5. The microwavable food container as defined in claim 4, wherein each of the water tanks comprises a specific capacity.

6. The microwavable food container as defined in claim 5, wherein the water pan comprises an internal bottom periphery and a plurality of annular walls located on the internal bottom periphery, whereby the water banks are defined between the internal periphery and the annular walls respectively.

7. The microwavable food container as defined in claim 6, wherein each of the annular walls comprise a top side aligned with a water level of one of the water tanks while it is full of the water.

8. The microwavable food container as defined in claim 4, wherein the water pan comprises an internal bottom periphery and a plurality of annular walls located on the internal bottom periphery, whereby the water banks are defined between the internal periphery and the annular walls respectively.

9. The microwavable food container as defined in claim 8, wherein each of the annular walls comprise a top side aligned with a water level of one of the water tanks while it is full of the water.
